(19) United States
(12) Patent Application Publication
(10) Pub. No.: US 2015/0380992 A1
(43) Pub. Date: Dec. 31, 2015

(54) Axial Gap-Type Electric Rotating Machine

(71) Applicant: HITACHI, LTD., Chiyoda-ku, Tokyo (JP)

(72) Inventors: Yuji ENOMOTO, Chiyoda-ku, Tokyo (JP); Hirooki TOKOI, Chiyoda-ku, Tokyo (JP); Kenta DEGUCHI, Chiyoda-ku, Tokyo (JP)

(73) Assignee: Hitachi ,Ltd.

(21) Appl. No.: 14/655,452

(22) PCT Filed: Jan. 23, 2013
(86) PCT No.: PCT/JP2013/051241

§ 371 Date: Jun. 25, 2015

(51) Int. Cl. H02K 1/18

(52) U.S. Cl. CPC H02K 1/182

(57) ABSTRACT

The grounding of a stator core with an inexpensive structure and high reliability is to be realized in an axial gap-type electric rotating machine in which a stator is held by resin molding. An axial gap-type electric rotating machine according to the invention includes: a stator having a stator core; a shaft penetrating the stator; a rotor arranged with a space from the stator with respect to the direction of the shaft; a housing which accommodates the stator; a first connection member which connects the stator core and the housing; and a resin material which fixes the stator to an inner wall of the housing. The first connection member is provided with a first connection portion which connects to the stator core, a second connection portion which connects to the inner wall of the housing, and a plastic deformation portion between the first connection portion and the second connection portion.

### TECHNICAL FIELD

The present invention relates to an electric rotating machine and particular to an axial gap-type electric rotating machine in which a stator is held by resin molding in a central part in the axial direction and in which a rotor is provided on both sides thereof in the axial direction.

### BACKGROUND ART

As an axial gap-type electric rotating machine, there is a two-rotor one-stator axial gap-type electric rotating machine having a structure in which a pair of disk-shaped rotors is arranged opposite each other in the direction of the rotation axis of the electric rotating machine and in which a stator is held between this pair of rotors with a predetermined gap. The rotor is made up of a rotor core and one or a plurality of magnets arranged in the circumferential direction. The stator is made up of a plurality of stator cores arranged in the circumferential direction and a coil wound around the stator cores. Such an axial gap-type electric rotating machine is described, for example, in PTL 1.

Meanwhile, in the case where the stator is held with a mold resin, the problem of electrolytic corrosion of the bearing arises. That is, since the stator core is electrically insulated by the mold resin and has a floating potential, a voltage is generated between the stator and the rotor by the electrostatic capacitance between the rotor and the stator. If this voltage is higher than the discharge start voltage of the oil film of the bearing, discharge occurs inside the bearing, reducing the life of the bearing. As a preventative measure for electrolytic corrosion of the bearing, a method of grounding the stator core is known (for example, PTL 2).

The stator described in PTL 1 is configured by having iron cores (stator cores) that are sectorial as viewed in the direction of the axial line with a coil wound around the iron cores, corresponding to a desired number of poles, arrayed in the circumferential direction to form a circular shape as a whole, and then mounting and supporting this in a case via a plate-like support member. Therefore, even if the stator cores are resin-molded, the stator cores can be grounded via the case by forming the plate-like support member of a conductive material.

However, in the two-rotor one-stator axial gap-type electric rotating machine described in PTL 1, since the stator has the coil divided to both sides of the plate-like support member by the plate-like support member, the connection of the coil is complicated and the number of components and the number of work processes involved in the connection increase.

PTL 2 discloses a method in which, in a radial gap-type mold motor, an iron core connection terminal is fixed to an outer peripheral part of a stator core and the iron core connection terminal is brought in contact with a conductive layer provided on a motor frame, thus achieving electrical continuity between the stator core and the conductive layer on the motor frame so as to ground the stator core. However, the grounding method described in PTL 2 cannot be applied to an axial gap-type electric rotating machine (particularly a two-rotor one-stator axial gap-type electric rotating machine). That is, if the stator core of the axial gap-type electric rotating machine does not have the division structure as described in PTL 1, the coil is wound on the entire circumference and therefore the iron core connection terminal cannot be provided on the outer peripheral part of the stator core.

Also, in the case where the stator core and the iron core connection terminal are brought in contact with each other on a gap surface where the stator core is exposed, there is also the problem that a magnetic flux generated by the coil acts on the iron core connection terminal and thus generates loss, and the problem of increase in the gap length due to the insertion of the iron core connection terminal.

Moreover, in the axial gap-type electric rotating machine in which a plurality of stator cores is arranged in the circumferential direction, in order to simultaneously ground all the plurality of stator cores arranged in the circumferential direction, these cores need to be connected by a component of an integrated structure. However, the structure is complicated. Also, since a disk-shaped hollow ring is to be used as the component, the utilization rate of material is low, resulting in high cost.

### CITATION LIST

### Patent Literature

PTL 1: JP-A-2005-269778

PTL 2: JP-A-2009-118628

### SUMMARY OF INVENTION

### Technical Problem

The problem according to the invention is to realize the grounding of a stator core with an inexpensive structure and high reliability, in an axial gap-type electric rotating machine in which a stator is held by resin molding.

### Solution to Problem

In order to solve the foregoing problem, an axial gap-type electric rotating machine according to the invention includes: a stator having a stator core; a shaft penetrating the stator; a rotor arranged with a space from the stator with respect to the direction of the shaft; a housing which accommodates the stator; a first connection member which connects the stator core and the housing; and a resin material which fixes the stator to an inner wall of the housing. The first connection member is provided with a first connection portion which connects to the stator core, a second connection portion which connects to the inner wall of the housing, and a plastic deformation portion between the first connection portion and the second connection portion.

### Advantageous Effect of Invention

According to the invention, the grounding of the stator core can be realized with an inexpensive structure and high reliability.

The other problems, configurations and effects than those described above will be clarified by the description of embodiments below.

### BRIEF DESCRIPTION OF DRAWINGS

FIG. 1 is a view showing the state inside a metal mold of an axial gap motor stator according to Example 1 of the invention.

FIG. 2(a) is a perspective view showing the structure of the gate top side of a top metal mold of the axial gap motor stator according to Example 1 of the invention.

FIG. 2(b) is a perspective view showing the structure of the gate bottom side of the top metal mold of the axial gap motor stator according to Example 1 of the invention.

FIG. 2 (c) is a cross-sectional view showing the positional relationship between a bottom-side protrusion of the metal mold of the axial gap motor stator and an inlet hole in a ground connection plate according to Example 1 of the invention.

FIG. 2(d) is a cross-sectional view showing the state where the bottom-side protrusion of the metal mold of the axial gap motor stator is pressurized into the inlet hole of the ground connection plate according to Example 1 of the invention.

FIG. 2(e) is a perspective view showing the structure of the ground connection plate according to Example 1 of the invention.

FIG. 3 is a perspective view showing the assembly state for explaining the positional relationship between the axial gap motor stator, a housing and the metal mold according to Example 1 of the invention.

FIG. 4(a) is a perspective view showing the assembly state for explaining the relationship between an axial gap motor stator core and a coil winding bobbin according to Example 1 of the invention

FIG. 4(b) is a perspective view for explaining the assembling positional relationship between the axial gap motor stator core, the coil winding bobbin and the ground connection plate according to Example 1 of the invention.

FIG. 4(c) is a perspective view for explaining the positional relationship between the positions of the axial gap motor stator core, the coil winding bobbin and the ground connection plate, and the inlet hole, according to Example 1 of the invention.

FIG. 5 is a perspective view showing the structure of a ground connection plate according to Example 2 of the invention.

FIG. 6(a) is a perspective view showing the structure for positioning and assembling the ground connection plate with a bottom metal mold according to Example 2 of the invention.

FIG. 6(b) is a perspective view showing the structure for positioning and assembling the ground connection plate and a winding bobbin with the bottom metal mold according to Example 2 of the invention.

FIG. 6(c) is a perspective view showing the structure for positioning and assembling the ground connection plate, the winding bobbin and a top ground connection plate according to Example 2 of the invention.

FIG. 7(a) is a perspective view showing the configuration of an axial gap motor using the stator of Example 1 of the invention.

FIG. 7(b) is a cross-sectional view showing the structure of an axial gap motor of one example of the invention, sliced along a plane B in FIG. 7(a).

### DESCRIPTION OF EMBODIMENTS

Hereinafter, examples of the invention will be described. In the description below, the case where the invention is applied to a two-rotor one-stator axial gap motor as an example of an axial gap-type electric rotating machine will be described. The two-rotor one-stator axial gap-type electric rotating machine has two rotors and therefore can use more magnetic fluxes of magnets than a one-rotor axial gap-type electric rotating machine. Thus, this is advantageous in terms of higher efficiency and higher output density.

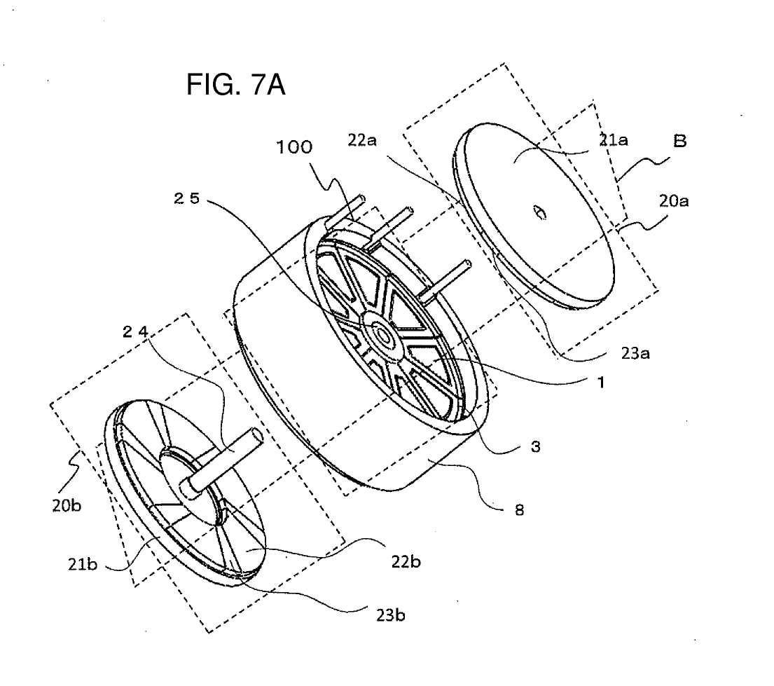

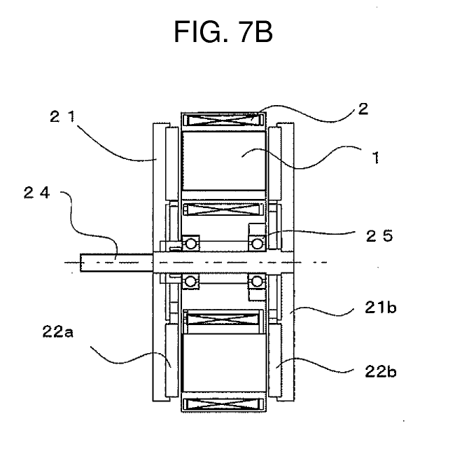

Using FIGS. 7(a) and 7(b), the schematic structure of the two-rotor one-stator axial gap motor applied to this embodiment will be described. FIG. 7(a) is a perspective view showing the structure of the two-rotor one-stator axial gap motor as an example of the invention. FIG. 7(b) is a cross-sectional view showing the structure of the axial gap motor as the example of the invention, sliced along a plane B in FIG. 7(a).

In the two-rotor one-stator axial gap motor, a pair of disk-shaped rotor 20a and rotor 20b is arranged opposite each other in the direction of the rotation axis, as shown in FIG. 7(a). A stator 100 is held between the pair of rotor 20a and rotor 20b via a predetermined gap.

The rotor 20b is mounted on a rotation shaft 24 via a rotor yoke 21b. The stator 100 is supported in a metallic housing 8 with a mold resin (not shown). A center part of the housing 8 has a structure where a bearing 25 is supported with the mold resin so as to rotatably support the rotor shaft 24.

The rotor 20a is formed by having one or a plurality of magnets 22a arranged in the circumferential direction and a spacer 23a arranged between the magnets, with the magnets 22a and the spacer 23a being held by a rotor yoke 21a. The rotor 20b is formed by having one or a plurality of magnets 22b arranged in the circumferential direction and a spacer 23b arranged between the magnets, with the magnets 22b and the spacer 23b held by the rotor yoke 21b.

In the invention, the rotor 20a and the rotor 20b are not limited to the structure shown in FIGS. 7(a) and 7(b) and the specific shape thereof may be arbitrary. For example, a configuration in which a magnetic material to prevent an eddy current is embedded in the rotor yoke 21a or the rotor yoke 21b may be employed.

The stator is formed by a plurality of stator cores 1 arranged in the circumferential direction and a coil 2 wound around each stator core 1, integrated by the mold resin, and held in the housing 8 via the mold resin. The coil 2 is wound on an insulative winding bobbin 3, and the stator cores 1 are arranged on the inner side of the bobbin 3. The stator cores 1 are molded with the mold resin and therefore electrically separated and insulated. Therefore, unless grounding is performed, the stator core 21a and the stator core 21b have a floating potential, generating a potential difference between the stator and the rotors. Then, since a shaft voltage is generated in the bearing 25 and a bearing current flows, electrolytic corrosion of the bearing occurs. Thus, a grounding structure for the stator core for preventing the stator core 1 from having a floating potential is needed.

### EXAMPLE 1

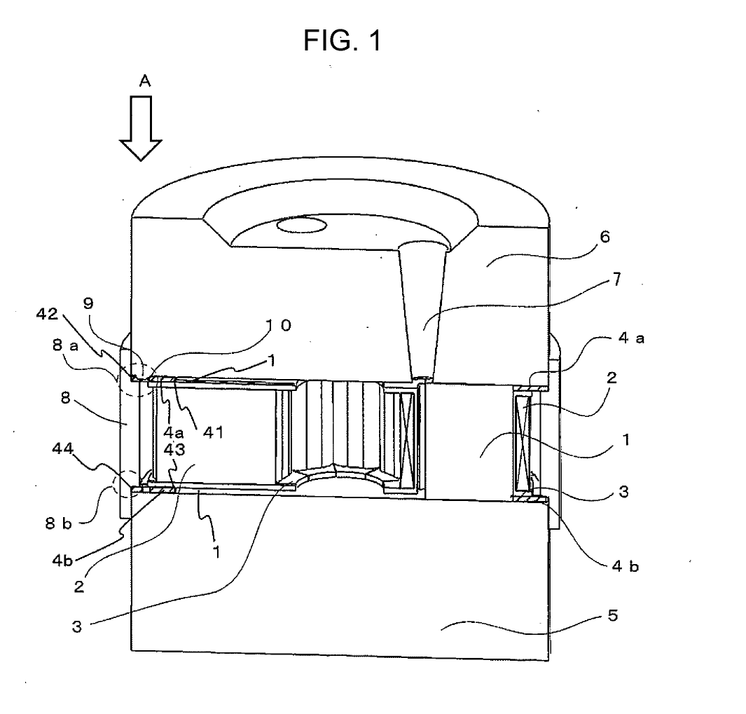

FIG. 1(a) shows a view of the state of stator components inside a metal mold at the time of molding an axial gap motor stator according to Example 1 of the invention. However, the illustration of a mold resin is omitted here.

In this example, the stator components are positioned and arranged at predetermined positions in a bottom metal mold 5, and a metallic housing 8 is arranged to surround these. A step portion 8b is formed in the axial direction on the inner peripheral side of the metallic housing 8, and the position in the axial direction with the bottom metal mold 5 is univocally decided.

Also, the stator has a structure in which a plurality of stator cores 1 and stator coils 2 wound around a coil winding bobbin 3 around the stator cores is arranged in the circumferential direction. The stator cores 1 are formed of a soft magnetic material and are structured to be ultimately held with a mold resin. Therefore, the stator cores 1 need to be electrically connected with the metallic housing 8.

Thus, a ground connection plate 4a and a ground connection plate 4b are arranged between the direction of the outer diameter of the stator cores 1 and the metallic housing 8. The ground connection plate 4a and the ground connection plate 4b function as electric connection members between the stator cores 1 and the metallic housing 8.

The length in the axial direction of the stator cores 1 is formed to be longer than the length in the axial direction of the winding bobbin 3, and a part of the stator cores 1 protrudes in the axial direction (direction of the rotation axis of the motor). The ground connection plate 4a and the ground connection plate 4b are arranged between an outer peripheral surface of the protruding parts of the stator cores 1 and an inner peripheral surface of the housing 8, and are structured with a ring-shaped nonmagnetic (paramagnetic) conductive material.

Since the ground connection plates are ring-shaped with the inner peripheral side thereof eliminated, if the ground connection plates are produced using a method such as pressing, there is a risk of a poor utilization rate of the material and high material cost. Therefore, the ground connection plate 4a and the ground connection plate 4b of the example are divided into a plurality of parts in the circumferential direction.

As the nonmagnetic conductive member used for the ground connection plate 4a and the ground connection plate 4b, for example, an aluminum alloy is used. Although a magnetic material may be used as the conductive member, it is desirable to use a nonmagnetic conductive member in order to effectively pass a magnetic flux through the stator cores.

The ground connection plate 4a shown in FIG. 1 is arranged on both sides in the axial direction of the stator cores 1 and has an inlet hole 10 for a plastic deformation punch 9 to be inserted, between the housing 8 and the stator cores 1. As the inlet hole 10, various shapes such as circular and square shapes may be considered. In this example, a circular shape is illustrated and described as a representative example. The inlet hole 10 functions as a plastic deformation portion.

The ground connection plate 4a and the ground connection plate 4b arranged in a plural number in the circumferential direction need to electrically connect the plurality of stator cores 1 with the housing 8, with high reliability. At the time of molding, there maybe cases where the resin flows in between the housing 8, and the ground connection plate 4a and the ground connection plate 4b, and therefore perfect contact with the ground connection plate 4a is not achieved because of variations in the positioning accuracy of the stator cores 1.

Therefore, it is necessary that the ground connection plate 4a and the ground connection plate 4b can be assembled and can easily perform electrical connection. Thus, at the time of molding, in the case of clamping a top metal mold 6, the plastic deformation punch 9 is arranged at a position in the circumferential direction of the top metal mold 6 and in the inlet hole 10 of the ground connection plate 4a. At the time of clamping, the inlet hole 10 is plastically deformed and deformed to perform electrical connection between the ground connection plate 4a and the housing 8 with high reliability. Specifically, the ground connection plate 4a is formed with a first connection portion 41 which connects to the stator core 1, and a second connection portion 42 which connects to the inner wall of the housing 8. Then, the inlet hole 10 is formed between the first connection portion 41 and the second connection portion 42.

At this time, the plastic deformation punch 9 applies a stress downward in the axial direction from above in the axial direction in FIG. 1. Therefore, the ground connection plate 4a is structured to be received by a step 8a of the housing so that the position of the ground connection plate 4a will not move due to the stress. Thus, the housing 8 and the ground connection plate 4a are caulked together and can be electrically connected with high strength. Particularly, the shaded parts of the ground connection plate 4a and the inlet hole 10 are formed to overlap with the shaded part of the step 8a, when projected from an axial direction A. Thus, electrical connection can be achieved with higher strength.

Also, similarly to the ground connection plate 4a, the ground connection plate 4b is formed with a third connection portion 43 which connects the stator core 1, a fourth connection portion 44 which connects to the inner wall of the housing 8, and an inlet hole (not shown) which functions as a plastic deformation portion between the third connection portion 43 and the fourth connection portion 44. Thus, in the axial gap-type electric rotating machine having the two rotors, a balance is taken between the potential difference on one side of the stator cores 1 and the potential difference on the other side of the stator cores 1 and the uneven presence of electrolytic corrosion of the bearing can thus be reduced.

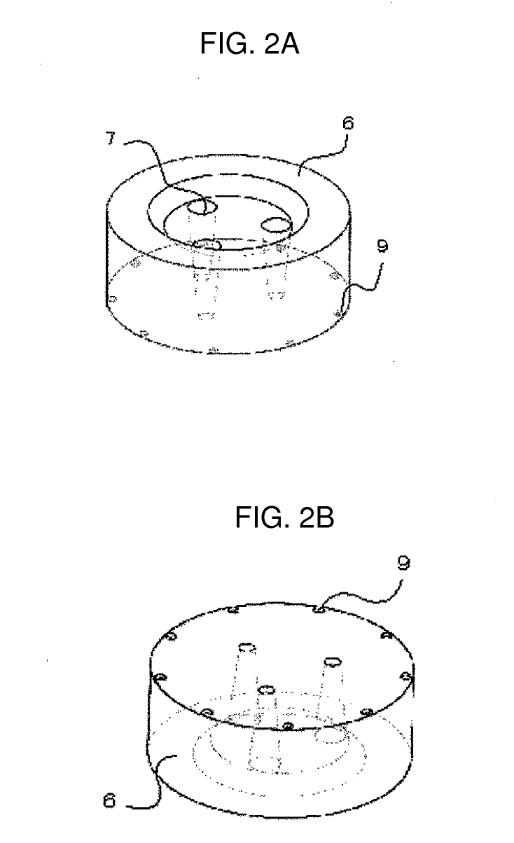

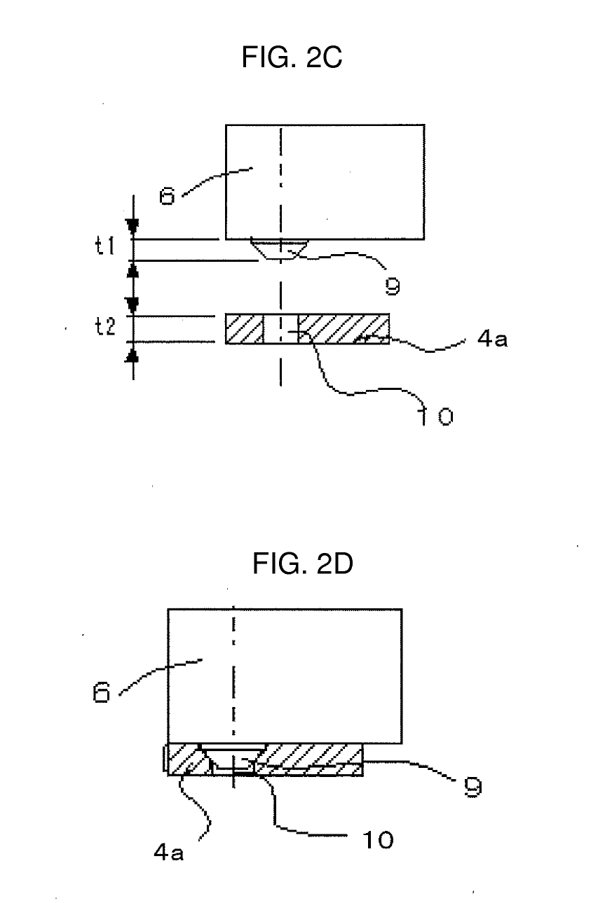

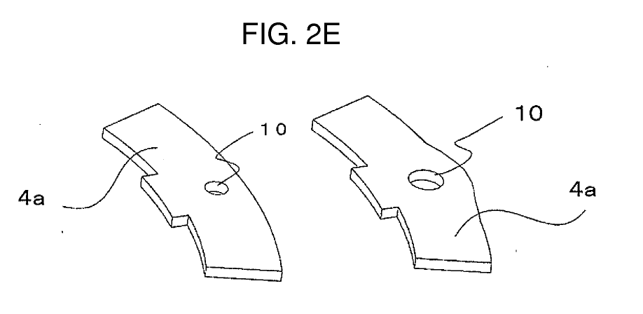

FIG. 2(a) shows a perspective view of the structure of the gate top side of the top metal mold 6 in Example 1 of the invention. In this example, three pin gates 7 are provided at three positions in a center part of the cylindrical metal mold.

FIG. 2(b) shows a perspective view of the top metal mold 6 as viewed from the back side. In a part near the outer periphery in the circumferential direction of the top metal mold 6, the plastic deformation punches 9 are configured in the forms of protrusions.

FIG. 2(c) shows the positional relationship between the cross section of the detailed shape of the plastic deformation punch 9 and the punch inlet hole 10 in the ground connection plate 4a before clamping (before plastic deformation). The diameter of the inlet hole 10 in the ground connection plate 4a is set to be smaller than the outermost diameter of the plastic deformation punch 9. Also, an amount of protrusion t1 of the plastic deformation punch 9 is set to be smaller than the thickness of the ground connection plate 4a, that is, a depth t2 of the inlet hole 10.

FIG. 2(d) shows the relationship between the plastic deformation punch 9 and the inlet hole 10 after clamping (after plastic deformation). Since the plastic deformation punch 9 having a greater diameter is inserted in the inlet hole 10 having a smaller diameter, the material around the inlet hole 10 is plastically deformed by the insertion of the punch 9, glides to the surroundings, and stretches out into an expanded state between the housing 8 and the stator cores 1. This state is shown in FIG. 2(e). The ground connection plate 4a, which is originally arc-shaped in the outer peripheral direction as shown on the left-hand side in FIG. 2(e), has the periphery thereof plastically deformed by the insertion of the plastic deformation punch 9, into the state where the inlet hole 10 is expanded as shown on the right-hand side in FIG. 2(e).

Since the housing 8 is not shown in FIG. 2(e), the ground connection plate 4a is shown as being expanded. However, the ground connection plate 4a plastically deformed in the housing 8 by the plastic deformation punch 9 stretches against the housing 8 and can securely electrically connected therewith. Thus, the plurality of stator cores arranged in the stator can be grounded with high reliability, without adding new processes and using the simple structure.

Also, in this example, the ground connection plate 4a also acts as a heat radiation path between the stator core 1 and the housing 8. Therefore, as the degree of coupling thereof becomes greater, thermal conductivity can be increased and temperature rise in the stator core 1 can be restrained.

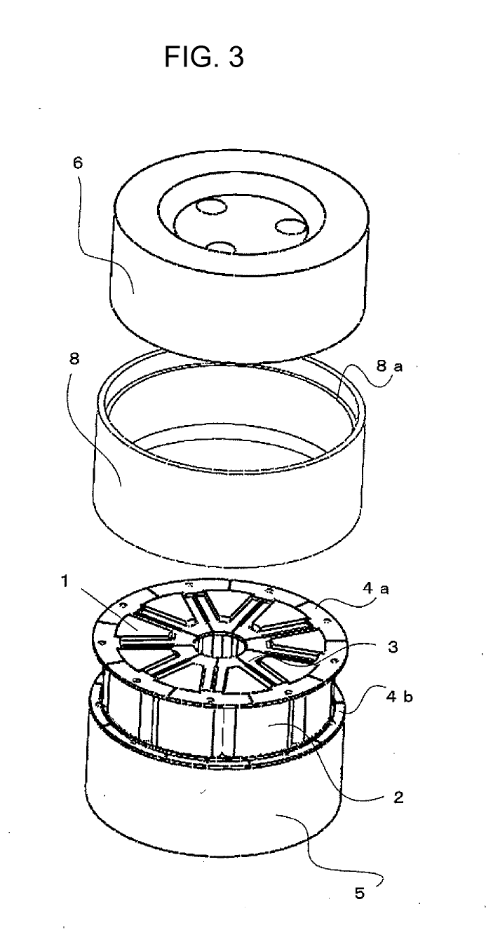

FIG. 3 is a perspective view of the order of assembly of the axial gap-type electric rotating machine according to this embodiment. On the ground connection plate 4b arranged in the circumferential direction on the bottom metal mold 5, the stator coil 2 wound on the bobbin 3 around the stator core 1 is arranged at an equal space.

Moreover, after the housing 8 with the stepped structure in the axial direction is laid over and arranged in the circumferential direction, the ground connection plate 4a is arranged at the position where the top surface of the step portion 8a of the housing and the top surface of the bobbin 3 are flush with each other. Over this, the top metal mold 6 having the gate portions 7 is hydraulically or otherwise clamped and assembled, and the resin is injected from the gate portions 7 to carry out resin molding, thus integrating the housing 8 with the components arranged in the circumferential direction such as the stator core 1.

### EXAMPLE 2

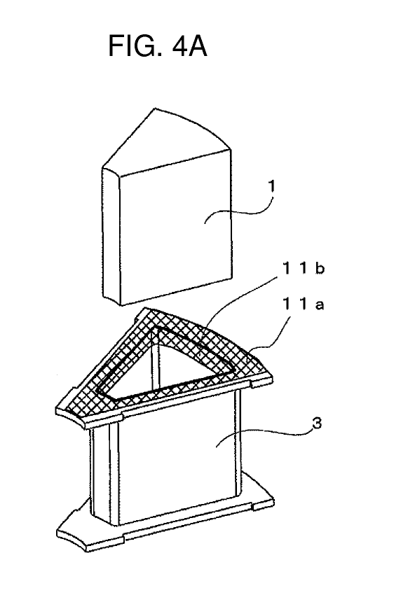

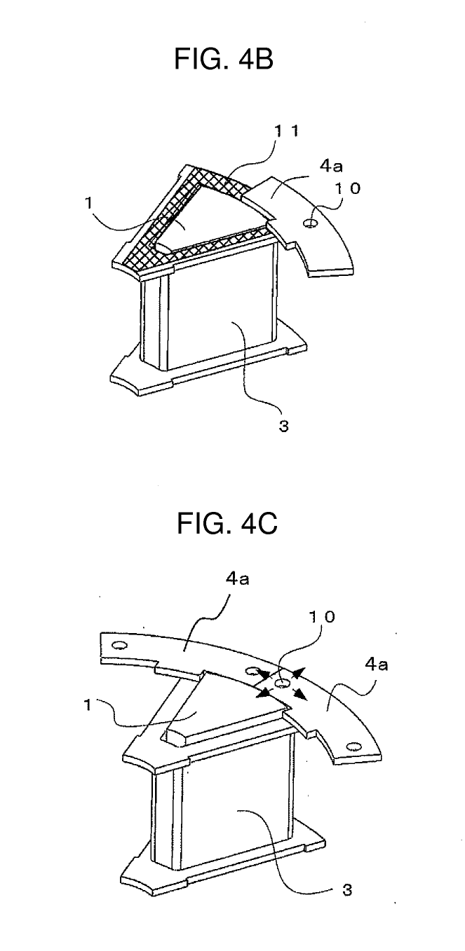

FIG. 4 shows the structure of the ground connection plate according to Example 2. In this example, the securing of electrical connection between the stator core 1 and the ground connection plate 4a will be explained.

Normally, the dimension of the stator core 1 is often set to be smaller than the dimension of the inner peripheral slot of the winding bobbin 3 in order to enable assembly into the winding bobbin 3. In such cases, with the method as described above, even if the ground connection plate 4a is arranged on the outer peripheral part of the stator core 1, there may be a case where the electrical connection is canceled because of an inward shift of the stator core 1 or the like.

To prevent such a phenomenon, in Example 2 of the invention, conductors such as conductive paint, conductive thin film or conductive plating are formed on the inner side of the winding bobbin 3 and the outside of the flange portion thereof, thus achieving secure electrical continuity between the stator core and these conductive members and secure electrical continuity between the conductive material on the surface of the flange part of the winding bobbin and the ground connection plate 4.

FIG. 4(a) illustrates a structure in which a conductive paint is applied at a part of the flange part of the winding bobbin 3, in a perspective view. The conductive paint may be applied to the entire inner peripheral part or may be applied to a predetermined depth as illustrated. In this state, the stator core 1 is inserted, thus forming a structure that enables electrical continuity between the stator core 1 and the conductive paint at a certain surface or point. FIG. 4(b) shows a structure in which the ground connection plate 4a is arranged on the outer diameter part of the bobbin 3 in the state of FIG. 4(a). Since the ground connection plate 4a is arranged on a conductive paint 11 on the flange part of the bobbin 3, the reliability of the electrical continuity between the conductive paint and the ground connection plate 4a is improved.

FIG. 4(c) shows an example in which the position of the inlet hole 10 is arranged between the stator core 1 and the housing 8. As the inlet hole 10 is arranged at such a position, a stress is applied in directions expanding in the circumferential direction of the inlet hole 10 when plastically deformed. Therefore, a structure is provided in which the housing 8 and the ground connection plate 4a, the ground connection plate 4a and the stator core 1, and the ground connection plates 4a that are next to each other in the circumferential direction are stretched firmly against each other and connected together.

### EXAMPLE 3

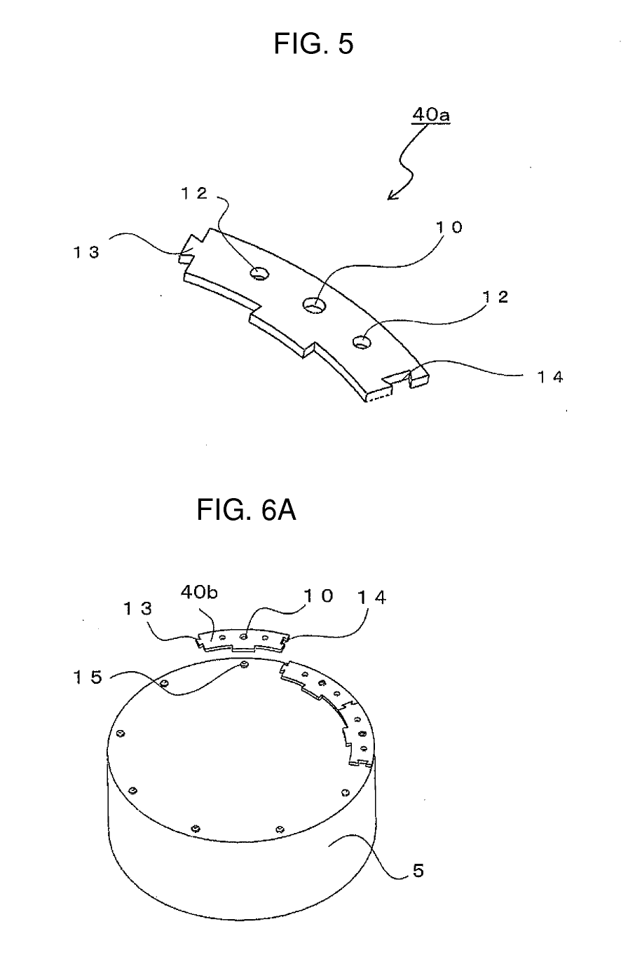

FIG. 5 shows another example of the ground connection plate. The ground connection plate in this example is characterized by having a structure in which a positioning hole for positioning is provided and in which the ground connection plates that are next to each other are connected in the form of recess-protrusion fitting.

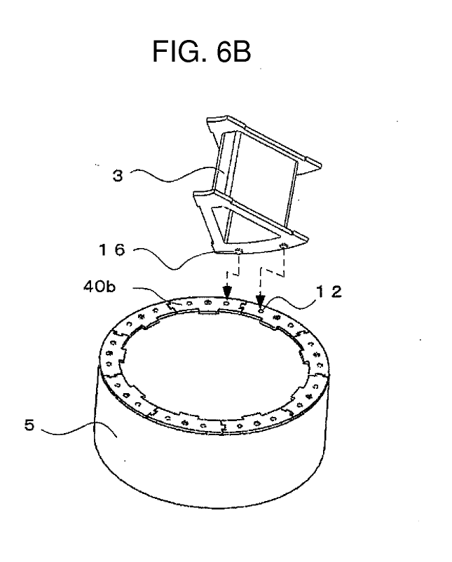

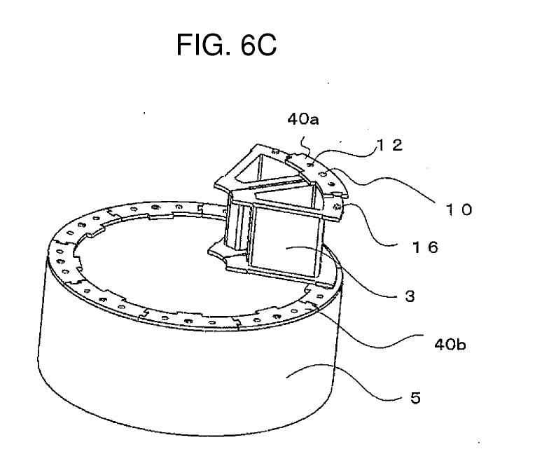

FIG. 6 shows the assembly structure of a ground connection plate 40a and a ground connection plate 40b according to this embodiment. FIG. 6(a) shows the process of assembling the bottom metal mold 5 and the ground connection plate 40b. The bottom metal mold 5 in this example has a protrusion 15 that fits with the positioning hole 10 in the ground connection plate 40b, and the ground connection plate 40b is assembled on the basis of the protrusion 15 as a reference. In this case, by providing a structure in which the ground connection plate 40b is combined with the next ground connection plate 40b via a protrusion and recess, assembly is facilitated and the ground connection plates can be held so as not to shift in the case of assembling the next component.

Then, as shown in FIG. 6, a structure is provided in which a protrusion 16 is also provided on the side of the bobbin 3 at the position to fit with the positioning hole 12 in the ground connection plate 40b, thus facilitating positioning and assembly.

Next, the assembly structure of the ground connection plate 40a is shown in FIG. 6(c). After the bobbin is assembled, the ground connection plate 40a is assembled via the positioning hole 12 to fit with the protrusion 16 on the bobbin 3, similarly to the ground connection plate 40b, thus enabling assembly with a good holding state in the temporary assembling state. After that, in the ground connection plate 40a, the positioning hole 10 that is not used functions as the inlet hole 10 for the insertion of the punch in Example 1, and secure electric connection between the housing 8 and the stator core 1 is achieved by the plastic deformation punch 9 of the metal mold.

### REFERENCE SIGNS LIST

1 . . . stator core, 2 . . . coil, 3 . . . winding bobbin, 4a . . . ground connection plate, 4b . . . ground connection plate, 5 . . . bottom metal mold, 6 . . . top metal mold, 7 . . . pin gate, 8a . . . step, 8b . . . step, 9 . . . plastic deformation punch, 10 . . . inlet hole or positioning hole, 41 . . . first connection portion, 42 . . . second connection portion, 43 . . . third connection portion, 44 . . . fourth connection portion

1. An axial gap-type electric rotating machine comprising:
a stator having a stator core;
a shaft penetrating the stator;
a rotor arranged with a space from the stator with respect to the direction of the shaft;
a housing which accommodates the stator;
a first connection member which connects the stator core and the housing; and
a resin material which fixes the stator to an inner wall of the housing;
the first connection member being provided with a first connection portion which connects to the stator core, a second connection portion which connects to the inner wall of the housing, and a plastic deformation portion between the first connection portion and the second connection portion.

2. The axial gap-type electric rotating machine according to claim 1, wherein
the housing is provided with a step portion, and
the first connection member is arranged on the step portion.

3. The axial gap-type electric rotating machine according to claim 2, wherein
if projected from an axial direction of the shaft,
the first connection member is formed in such a way that a shaded part of the plastic deformation portion overlaps with a shaded part of the step portion.

4. The axial gap-type electric rotating machine according to claim 1, wherein
a plurality of the first connection member is provided,
one first connection member of the plurality of the first connection members is formed with a protruding portion, and
another first connection member of the plurality of the first connection members is formed with a recessed portion which fits with the protruding portion.

5. The axial gap-type electric rotating machine according to claim 1, comprising
a second rotor opposite the first rotor with the stator being in-between, and
a second connection member which connects the stator core and the housing,
wherein the first connection member is arranged on a surface of the stator that is closer to the first rotor,
the second connection member is arranged on a surface of the stator that is closer to the second rotor, and
the second connection member is further provided with a third connection portion which connects the stator core, a fourth connection portion which connects to the inner wall of the housing, and a second plastic deformation portion between the third connection portion and the fourth connection portion.

6. The axial gap-type electric rotating machine according to claim 1, wherein
the stator is provided with a plurality of stator units in a circumferential direction, each stator unit being formed by a core, a bobbin, and a winding wound on the bobbin,
the bobbin is formed by a cylindrical portion which accommodates the core, and a flange portion connected with the cylindrical portion,
the first connection member is arranged on the flange portion via a conductive member, and
the conductive member contacts the core and the first connection member.

7. The axial gap-type electric rotating machine according to claim 6, wherein
the conductive member is formed up to a space between the core and the cylindrical portion, and
the conductive member further contacts a surface of the core that is opposite the cylindrical portion.

8. The axial gap-type electric rotating machine according to claim 1, wherein
the stator is provided with a plurality of stator units in a circumferential direction, each stator unit being formed by a core, a bobbin, and a winding wound on the bobbin,
the bobbin is formed by a cylindrical portion which accommodates the core, and a flange portion connected with the cylindrical portion,
the flange portion is formed with a flange-side engagement portion,
the first connection member is arranged opposite the flange portion of one of two stator units that are next to each other and the flange portion of the other of the two stator units that are next to each other, and
the first connection member is further provided with a first engagement portion which connects to the flange-side engagement portion of one of the two stator units that are next to each other, and a second engagement portion which connects to the flange-side engagement portion of the other of the two stator units that are next to each other.
